(19) United States
(12) Patent Application Publication
(10) Pub. No.: US 2004/0268414 A1
(43) Pub. Date: Dec. 30, 2004

(54) Set-top box functionality in personal computer

(76) Inventors: Shlomo Turgeman, Ramat Efal (IL); Nachum Panich, Ramat Gan (IL)

Correspondence Address: Dekel Patent Ltd., Beit HaRofim, Room 27, 18 Menuha VeNahala Street, Rehovot, 76209, IL

(21) Appl. No.: 10/872,399

(22) Filed: Jun. 22, 2004

Related U.S. Application Data
(60) Provisional application No. 60/482,004, filed on Jun. 25, 2003.

(51) Int. Cl. H04N 7/173; H04N 7/18; H04N 7/16

(52) U.S. Cl. 725/131; 725/139; 725/80; 725/151

(57) ABSTRACT

Apparatus and methods for providing set-top box features and functionality in an integrated circuit (chip) and/or printed circuit board (PCB).

### CROSS REFERENCE TO OTHER APPLICATIONS

This application claims priority from U.S. provisional patent application No. 60/482,004, filed 25 Jun. 2003.

### FIELD OF THE INVENTION

The present invention relates generally to apparatus and methods for providing set-top box features and functionality in an integrated circuit (chip) and/or printed circuit board (PCB) that may convert a personal computer (PC) into a digital TV receiver or pay-TV receiver, such as but not limited to, receiving subscription television services which may be provided by cable or satellite.

### BACKGROUND OF THE INVENTION

Cable television and satellite television services are generally provided through the use of a stand-alone set-top box (STB) converter which converts signals from the cable or satellite television system into signals that can be displayed on a standard television. Various approaches combining both the television and the set-top box have been considered in order to obviate the necessity for a stand-alone set-top box.

For example, U.S. Pat. No. 6,271,837 to Naiff describes a peripheral device that enables the PC to provide the functions of a set-top box for television reception. The television operations take place in the multitasking environment of the PC, so that the PC can be concurrently used for other applications. The peripheral includes a television interface for enabling the PC to receive, select and process television signals, which may be digital or analog. A communications port operatively associated with the television interface communicates the television signals processed by the interface to a television appliance such as a television set, VCR, or the like.

The television interface can comprise audio and/or video decompression means for decoding (e.g., digitally) the television signals. PC application software operatively associated with the peripheral device is adapted to run on the PC for controlling television functions provided by the television interface. For example, the software can provide an electronic program guide function to the television appliance via the television interface. The software is advantageously adapted to run in a multitasking mode with other unrelated applications in the PC. For example, the PC can run a Windows operating environment wherein the software associated with the peripheral device is multitasked with other applications. In this manner, television services provided on the television appliance and unrelated applications provided on the PC can be concurrently accessed. Thus, for example, one person may be watching a television program on a television set receiving signals from the television interface of the PC, while another person is concurrently running PC applications directly on the PC. The PC is thus shared by both users, whereby the person viewing television programs can interact with the television and television service provider without affecting the work being done by the second person on the PC. The PC monitor can also be used to independently display television programs in addition to having programs displayed (or recorded) on the separate television appliance.

### SUMMARY OF THE INVENTION

The present invention seeks to provide apparatus and methods for providing set-top box features and functionality in an integrated circuit (chip) and/or printed circuit board (PCB) that may convert a personal computer (PC) into a digital TV receiver or pay-TV receiver, as is described more in detail hereinbelow. For example, composite video and audio may be converted from a digital signal source into a standard (e.g., NTSC, PAT, SECAM, etc.) television format without the need for a set-top box. The invention has applications in many fields, such as but not limited to, receiving subscription television services which may be provided by cable or satellite.

### BRIEF DESCRIPTION OF THE DRAWINGS

The present invention will be understood and appreciated more fully from the following detailed description taken in conjunction with the drawing in which:

FIG. 1 is a simplified block diagram illustration of apparatus and methods for providing set-top box features and functionality in a chip and/or PCB, in accordance with an embodiment of the present invention.

### DETAILED DESCRIPTION OF THE PREFERRED EMBODIMENT

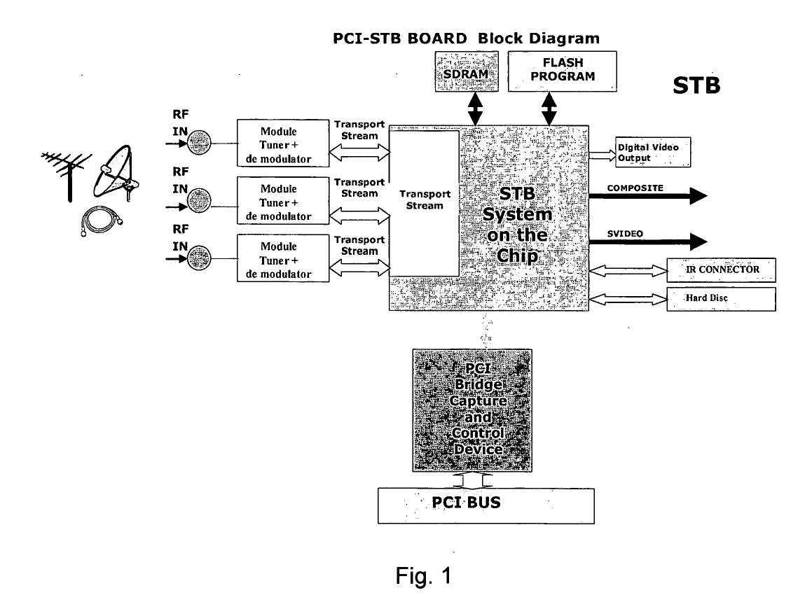

Reference is now made to FIG. 1, which illustrates apparatus and methods for providing set-top box features and functionality in a chip and/or PCB, in accordance with an embodiment of the present invention.

The apparatus may comprise inputs for RF from cable, satellite or any other kind of TV input. Tuner and demodulators receive the TV input and a transport stream is output therefrom to a chip that includes STB functionality, referred to as “STB system on the chip”. STB functionality may include, without limitation, subscriber information and access capability, and decoding (or even encoding) capability. Various memories may be provided for the function of the system, such as but not limited to, static or dynamic random access memories or flash memories.

The “STB system on the chip” may output to a personal computer interface (PCI) bus via a PCI bridge capture and control device.

The “STB system on the chip” may output digital video output, composite or simple video, and may communicate with the hard disc of the PC or some peripheral device, such as via an IR connector.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. Apparatus and methods for providing set-top box features and functionality in an integrated circuit (chip) and/or printed circuit board (PCB), substantially as shown and described hereinabove.
